(19) United States
(12) Patent Application Publication
(10) Pub. No.: US 2021/0335244 A1
(43) Pub. Date: Oct. 28, 2021

(54) DISPLAY DEVICE

(71) Applicant: JOLED INC., Tokyo (JP)

(72) Inventor: Masanori OHARA, Tokyo (JP)

(73) Assignee: JOLED INC., Tokyo (JP)

(21) Appl. No.: 17/237,526

(22) Filed: Apr. 22, 2021

(30) Foreign Application Priority Data
Apr. 28, 2020 (JP) 2020-078857

(51) Int. Cl. G09G 3/3233

(52) U.S. Cl. CPC G09G 3/3233; G09G 2300/0439

(57) ABSTRACT

A display device includes a pixel circuit that includes a light emitting element; and a control circuit that controls light emission of the light emitting element via the pixel circuit. The pixel circuit includes a drive transistor circuit that is driven to supply a pixel current to the light emitting element, and the drive transistor circuit includes a first drive transistor that is a polysilicon semiconductor transistor and a second drive transistor that is an oxide semiconductor transistor.

### CROSS REFERENCE TO RELATED APPLICATION

The present application is based on and claims priority of Japanese Patent Application No. 2020-078857 filed on Apr. 28, 2020. The entire disclosure of the above-identified application, including the specification, drawings and claims is incorporated herein by reference in its entirety.

### FIELD

The present disclosure relates to an active matrix type display device.

### BACKGROUND

Conventionally, an active matrix type display device using organic electro-luminescence (EL) light emitting elements has been put into practical use (see, for example, Patent Literature (PTL) 1 and the like). This display device is configured by arranging a plurality of pixel circuits including light emitting elements, drive transistors, and the like in a matrix. In the display device, the light emission of the light emitting element is controlled by controlling the pixel current supplied to the light emitting element by using a drive transistor or the like.

### CITATION LIST

### Patent Literature

PTL 1: Japanese Unexamined Patent Application Publication No. 2018-93082

### SUMMARY

### Technical Problem

With a conventional display device, when the display gradation is a low gradation, it may become difficult to control the pixel current supplied to the light emitting element, and the display quality of the image may deteriorate. In addition, when the display gradation is a high gradation, the drive transistor receives current stress, so that the characteristics of the drive transistor may fluctuate, and the brightness of the image may decrease.

Therefore, an object of the present disclosure is to provide a display device that suppresses deterioration of the display quality of an image when the display gradation is a low gradation, or a display device that suppresses a decrease in the brightness of an image when the display gradation is a high gradation.

### Solution to Problem

In order to achieve the above object, the display device according to one aspect disclosed includes a pixel circuit that includes a light emitting element; and a control circuit that controls light emission of the light emitting element via the pixel circuit, wherein the pixel circuit includes a drive transistor circuit that is driven to supply a pixel current to the light emitting element, and the drive transistor circuit includes a first drive transistor that is a polysilicon semiconductor transistor and a second drive transistor that is an oxide semiconductor transistor.

In order to achieve the above object, the display device according to one aspect disclosed includes a pixel circuit that includes a light emitting element; and a control circuit that controls light emission of the light emitting element via the pixel circuit, wherein the pixel circuit includes a drive transistor circuit that is driven to supply a pixel current to the light emitting element, the drive transistor circuit includes a first drive transistor and a second drive transistor, and the second drive transistor has a smaller slope of a linear characteristic indicating a relationship between a gate-source voltage and the pixel current than the first drive transistor.

### Advantageous Effects

According to the display device according to the present disclosure, it is possible to suppress deterioration of the display quality of an image when the display gradation is a low gradation. In addition, according to the display device according to the present disclosure, it is possible to suppress a decrease in the brightness of an image when the display gradation is a high gradation.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing an example of a functional configuration of a display device of a comparative example.

FIG. 2 is a circuit diagram showing an example of a configuration of a pixel circuit of the display device of the comparative example.

FIG. 3 is a diagram showing a characteristic of a polysilicon semiconductor transistor.

FIG. 4 is a diagram showing the characteristic of an oxide semiconductor transistor.

FIG. 5 is a block diagram showing an example of a functional configuration of a display device according to the embodiment.

FIG. 6 is a circuit diagram showing an example of a configuration of a pixel circuit included in the display device according to the embodiment.

FIG. 7 is a diagram showing the relationship between the gate-source voltage of the drive transistor and the pixel current.

FIG. 8 is a diagram showing the relationship between the current stress of the drive transistor and the light emission start voltage.

FIG. 9 is a diagram showing an example of the operation of the display device according to the embodiment per frame.

FIG. 10 is a diagram showing the relationship between the gradation height and the brightness of the display image.

FIG. 11 is a flowchart showing an example of a mode switching method of the display device according to the embodiment.

FIG. 12 is a timing chart showing an example of a driving method of the display device according to the embodiment.

FIG. 13 is a cross-sectional view schematically showing the structure of the display of the display device according to the embodiment.

FIG. 14 is a cross-sectional view schematically showing the structure of the display of the display device according to the variation of the embodiment.

### DESCRIPTION OF EMBODIMENTS

### (Process Leading to the Present Disclosure)

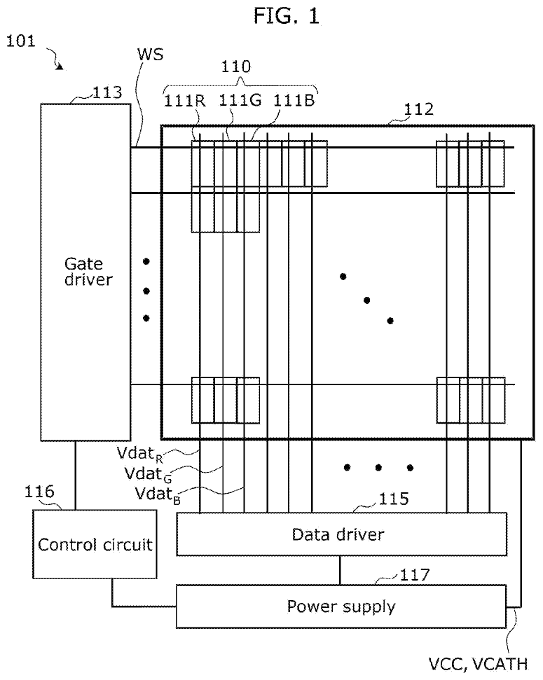

The process leading to the present disclosure will be described with reference to FIG. 1 to FIG. 4.

FIG. 1 is a block diagram showing an example of a functional configuration of display device 101 of the comparative example. In the following description, for the sake of brevity, the signal and the wiring that transmits the signal may be referred to by the same reference numeral. In addition, the circuit and the region where the circuit is formed may be referred to by the same reference numeral.

As shown in FIG. 1, display device 101 of the comparative example includes display 112, gate driver 113, data driver 115, control circuit 116, and power supply 117.

Display 112 includes a plurality of pixel circuits 110 arranged in a matrix. Each pixel circuit 110 is configured by sub-pixel circuits 111R, 111G, and 111B corresponding to the emission colors of R, G, and B, respectively.

Each row of the matrix is provided with write signal line WS connected to a plurality of pixel circuits 110 arranged in the same row. Write signal WS supplied from gate driver 113 to pixel circuit 110 is transmitted through write signal line WS.

Each column of the matrix is provided with three data signal lines Vdat_{R}, Vdat_{G}, and Vdat_{B} connected to a plurality of pixel circuits 110 arranged in the same column. Hereinafter, data signal lines Vdat_{R}, Vdat_{G}, and Vdat_{B} may be collectively referred to as data signal line Vdat. Each data signal line Vdat transmits each data signal Vdat related to the emission brightness of R, G, and B supplied from data driver 115 to each pixel circuit 110.

Control circuit 116 receives a video signal from the outside, and outputs a control signal for displaying an image of each frame of the video signal on display 112 to gate driver 113 and data driver 115.

Power supply 117 supplies the power supply voltage to display 112, gate driver 113, data driver 115, and control circuit 116. In addition, power supply 117 supplies positive power supply voltage VCC and negative power supply voltage VCATH to display 112.

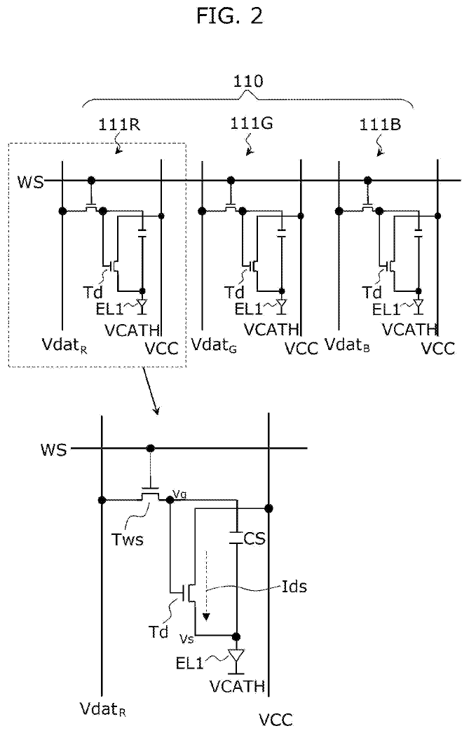

FIG. 2 is a circuit diagram showing an example of the configuration of pixel circuit 110 of display device 101 of the comparative example. As shown in FIG. 2, sub-pixel circuits 111R, 111G, and 111B configuring pixel circuit 110 have the same configuration as one another. Hereinafter, the configuration of pixel circuit 110 will be described with a focus on sub-pixel circuit 111R.

Sub-pixel circuit 111R includes write transistor Tws, holding capacitance CS, drive transistor Td, and light emitting element EL1. In addition, sub-pixel circuit 111R includes a part of each of write signal line WS, data signal line Vdat_{R}, positive power supply line VCC, and negative power supply line VCATH.

When write transistor Tws is turned on according to write signal WS, the gradation data voltage applied from data driver 115 via data signal line Vdat is held in holding capacitance CS. When write transistor Tws is turned off, gate-source voltage (potential difference between gate node potential Vg and source node potential Vs) Vgs of drive transistor Td is determined, and pixel current Ids corresponding to gate-source voltage Vgs is supplied to light emitting element EL1. Light emitting element EL1 is controlled to emit light based on pixel current Ids supplied via drive transistor Td.

As drive transistor Td, for example, a field effect transistor such as a polysilicon semiconductor transistor or an oxide semiconductor transistor is used. Here, each characteristic of the polysilicon semiconductor transistor and the oxide semiconductor transistor will be described.

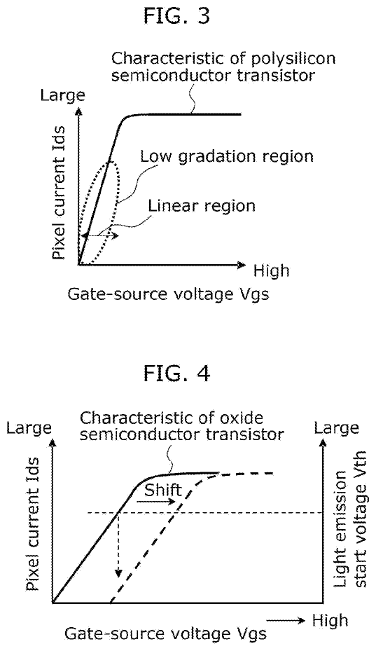

FIG. 3 is a diagram showing the characteristic of the polysilicon semiconductor transistor. FIG. 3 shows the relationship between pixel current Ids and gate-source voltage Vgs of the polysilicon semiconductor transistor.

As shown in FIG. 3, the polysilicon semiconductor transistor includes a characteristic that the slope in the linear region, that is, the slope of the linear characteristic is large in the figure showing the relationship between pixel current Ids and gate-source voltage Vgs. Therefore, when a polysilicon semiconductor transistor is used as drive transistor Td, it may be difficult to control pixel current Ids supplied to light emitting element EL1 when the display gradation is a low gradation, for example. Specifically, when the slope of the linear characteristic shown in FIG. 3 is large, the voltage width of gate-source voltage Vgs per predetermined unit gradation becomes small, and it becomes difficult to set the gradation data voltage appropriately using data driver 115. With this, for example, voltage reversal of adjacent gradations or deterioration of repeatability may occur, and the display quality of the image may be deteriorated.

FIG. 4 is a diagram showing the characteristic of the oxide semiconductor transistor. FIG. 4 shows the relationship between pixel current Ids and gate-source voltage Vgs of the oxide semiconductor transistor.

When current stress is applied to the oxide semiconductor transistor due to a large current flowing between the drain and the source (between the drain node and the source node), characteristic fluctuations may occur, such as a shift in gate-source voltage Vgs related to the light emission start voltage of light emitting element EL1, as shown in FIG. 4. For that reason, if an oxide semiconductor transistor is used as drive transistor Td and continued to be used at a high gradation with a large current stress, pixel current Ids does not flow as before even if gate-source voltage Vgs is the same, and the brightness of the image may deteriorate.

Therefore, the display device of the present disclosure includes a configuration of including a plurality of drive transistors, selecting one of the plurality of drive transistors according to the high and low gradation of the display image, and supplying pixel current Ids to light emitting element EL1 via the selected drive transistor. For example, the display device of the present disclosure supplies pixel current Ids to light emitting element EL1 via a drive transistor different from a polysilicon semiconductor transistor, that is, a drive transistor having a small slope of a linear characteristic showing the relationship between pixel current Ids and gate-source voltage Vgs, when the display gradation is a low gradation. In addition, in the display device of the present disclosure, when the display gradation is a high gradation, pixel current Ids is supplied to light emitting element EL1 via a drive transistor different from the oxide semiconductor transistor, that is, a drive transistor having a small characteristic fluctuation with respect to current stress.

According to this, it is possible to suppress deterioration of the display quality of the image when the display gradation is a low gradation. In addition, it is possible to suppress a decrease in the brightness of the image when the display gradation is a high gradation.

Hereinafter, embodiments of the present disclosure will be described in detail with reference to the drawings. It should be noted that all of the embodiments described below are comprehensive or specific examples. Numerical values, shapes, materials, components, arrangements and connection forms of the components, and the like shown in the following embodiments are examples, and are not intended to limit the present disclosure.

### Embodiment

### [1. Configuration of Display Device]

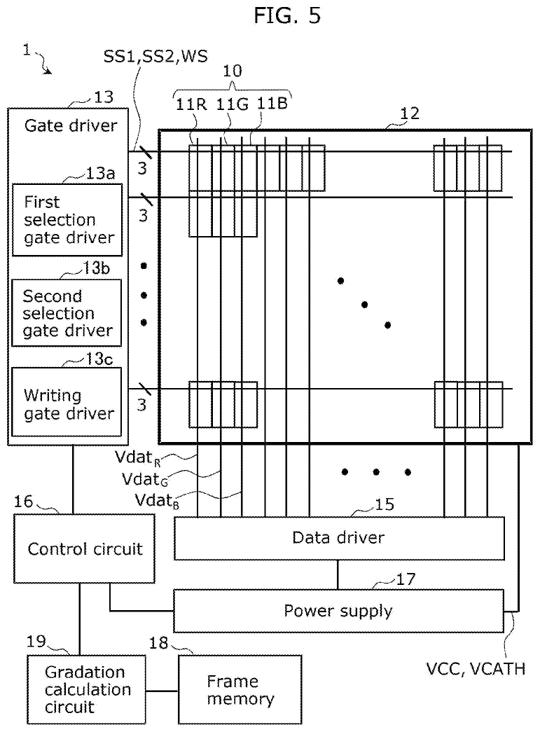

The configuration of the display device according to an embodiment will be described with reference to FIG. 5 to FIG. 8.

FIG. 5 is a block diagram showing an example of a functional configuration of display device 1 according to the embodiment. In the following description, for the sake of brevity, a signal and a wiring that transmits the signal may be referred to by the same reference numeral. In addition, a circuit and a region where the circuit is formed may be referred to by the same reference numeral.

As shown in FIG. 5, display device 1 includes display 12, gate driver 13, data driver 15, control circuit 16, and power supply 17. In addition, display device 1 further includes frame memory 18 and gradation calculation circuit 19.

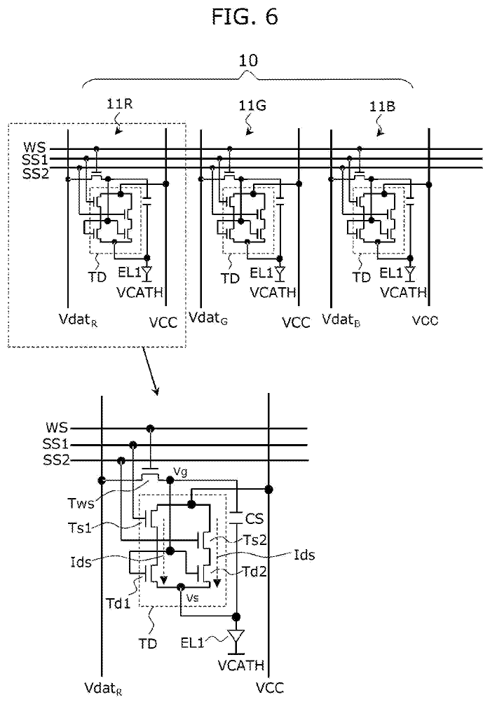

Display 12 includes a plurality of pixel circuits 10 arranged in a matrix. Each pixel circuit 10 is configured by sub-pixel circuits 11R, 11G, and 11B corresponding to the emission colors of R, G, and B, respectively. Each of sub-pixel circuits 11R, 11G, and 11B includes organic electro-luminescence (EL) light emitting element EL1 and drive transistor circuit TD including a plurality of drive transistors (see FIG. 6).

Each row of the matrix of display 12 is provided with three control signal lines connected to a plurality of pixel circuits 10 arranged in the same row. The three control signal lines are selection signal lines SS1 and SS2, and write signal line WS. Each column of the matrix of display 12 is provided with three data signal lines Vdat (that is, Vdat_{R}, Vdat_{G}, and Vdat_{B}) connected to a plurality of pixel circuits 10 arranged in the same column.

Power supply 17 supplies a power supply voltage to display 12, gate driver 13, data driver 15, and control circuit 16. In addition, power supply 17 supplies positive power supply voltage VCC and negative power supply voltage VCATH to display 12.

Frame memory 18 is a memory for storing the video signal obtained by display device 1. Frame memory 18 includes a storage capacity capable of storing, for example, a video signal for at least one frame. The video signal stored in frame memory 18 is output to gradation calculation circuit 19.

Gradation calculation circuit 19 performs calculation processing of the number of gradations of the display image displayed on display 12 and outputs a mode switching signal. For example, gradation calculation circuit 19 determines whether the display image should be displayed in the low gradation mode or the high gradation mode based on the above calculation processing, and outputs the determination result to control circuit 16 as the mode switching signal.

Control circuit 16 obtains a video signal from the outside and outputs a control signal for displaying an image of each frame of the video signal on display 12 to gate driver 13 and data driver 15. Control circuit 16 includes a function of controlling the drive timing of gate driver 13 and data driver 15.

In addition, control circuit 16 selects a drive transistor for supplying pixel current Ids to light emitting element EL1 based on the mode switching signal output from gradation calculation circuit 19. Control circuit 16 includes a gamma lookup table, and outputs data signal Vdat corresponding to the selected drive transistor to data driver 15.

Gate driver 13 includes first selection gate driver 13a, second selection gate driver 13b, and writing gate driver 13c. Writing gate driver 13c transmits write signal WS to pixel circuit 10 via write signal line WS. First selection gate driver 13a transmits selection signal SS1 to pixel circuit 10 via selection signal line SS1. Second selection gate driver 13b transmits selection signal SS2 to pixel circuit 10 via selection signal line SS2.

Data driver 15 transmits respective data signals Vdat related to the emission brightness of R, G, and B to respective pixel circuits 10 via respective data signal lines Vdat. Respective pixel circuits 10 are controlled based on these various signals.

FIG. 6 is a circuit diagram showing an example of the configuration of pixel circuit 10 included in display device 1.

As shown in FIG. 6, pixel circuit 10 includes write transistor Tws, holding capacitance CS, drive transistor circuit TD, and light emitting element ELL In addition, pixel circuit 10 includes a part of each of write signal line WS, selection signal lines SS1 and SS2, data signal line Vdat, positive power supply line VCC, and negative power supply line VCATH.

Drive transistor circuit TD is a circuit for supplying pixel current Ids to light emitting element ELL Drive transistor circuit TD includes first drive transistor Td1, second drive transistor Td2, first selection transistor Ts1, and second selection transistor Ts2.

The other end of the input/output terminals of first selection transistor Ts1 is connected to one end of the input/output terminals of first drive transistor Td1. The other end of the input/output terminals of second selection transistor Ts2 is connected to one end of the input/output terminals of second drive transistor Td2. First drive transistor Td1 and first selection transistor Ts1, and second drive transistor Td2 and second selection transistor Ts2 are connected in parallel.

It should be noted that when the transistor is a field effect transistor, for example, one end of the input/output terminals is a drain, the other end of the input/output terminals is a source, and the control terminal is a gate.

One end side of drive transistor circuit TD, that is, one end of the input/output terminals of first selection transistor Ts1 and one end of the input/output terminals of second selection transistor Ts2 are connected to positive power supply line VCC. The other end side of drive transistor circuit TD, that is, the other end of the input/output terminals of first drive transistor Td1 and the other end of the input/output terminals of second drive transistor Td2 are connected to the anode of light emitting element EL1. The control terminal of first selection transistor Ts1 is connected to selection signal line SS1, and the control terminal of second selection transistor Ts2 is connected to selection signal line SS2.

The control terminal of write transistor Tws is connected to write signal line WS. The other end of the input/output terminals of write transistor Tws is connected to data signal line Vdat, and one end of the input/output terminals of write transistor Tws is connected to holding capacitance CS.

One end of holding capacitance CS is connected to one end of the input/output terminals of write transistor Tws and to the gate side of the drive transistor (the control terminal of first drive transistor Td1 and the control terminal of second drive transistor Td2). The other end of holding capacitance CS is connected to the anode of light emitting element EL1.

The anode of light emitting element EL1 is connected to the other end of holding capacitance CS and the other end side of drive transistor circuit TD. The cathode of light emitting element EL1 is connected to negative power supply line VCATH.

When write transistor Tws is turned on according to write signal WS, the gradation data voltage applied from data driver 15 via data signal line Vdat is held in holding capacitance CS. When write transistor Tws is turned off, gate-source voltage Vgs of each of drive transistors Td1 and Td2 in drive transistor circuit TD is determined, and pixel current Ids according to gate-source voltage Vgs is supplied to light emitting element EL1 via drive transistor Td1 or Td2. Light emitting element EL1 is controlled to emit light based on pixel current Ids supplied via drive transistor circuit TD.

In the present embodiment, a polysilicon semiconductor transistor is used as first drive transistor Td1, and an oxide semiconductor transistor is used as second drive transistor Td2. Examples of polysilicon semiconductor transistors include low temperature polysilicon semiconductor transistors and high temperature polysilicon semiconductor transistors. A pc silicon semiconductor transistor may be used instead of the polysilicon semiconductor transistor. Examples of oxides of oxide semiconductor transistors include compounds of In, Ga, Zn and O, and compounds of In, Sn (TiO), Zn and O.

Here, the respective characteristics of the polysilicon semiconductor transistor and the oxide semiconductor transistor will be described.

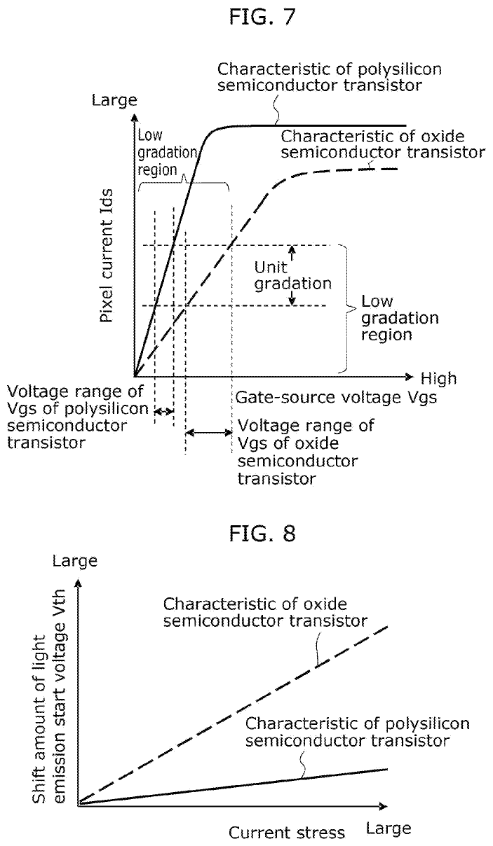

FIG. 7 is a diagram showing the relationship between gate-source voltage Vgs and pixel current Ids of the drive transistor. FIG. 7 shows the relationship between gate-source voltage Vgs of each of the low-temperature polysilicon semiconductor transistor and the oxide semiconductor transistor, and pixel current Ids.

In FIG. 7, when the display gradation is a low gradation, that is, when gate-source voltage Vgs is relatively low, the oxide semiconductor transistor has a smaller linear characteristic slope than the polysilicon semiconductor transistor. For that reason, when the display gradation is a low gradation, if an oxide semiconductor transistor is used as the drive transistor for supplying pixel current Ids, the voltage width of gate-source voltage Vgs per gradation can be increased. That is, by using an oxide semiconductor transistor as the drive transistor, the voltage difference from the adjacent gradation can be increased, and pixel current Ids can be easily controlled.

FIG. 8 is a diagram showing the relationship between the current stress of the drive transistor and light emission start voltage Vth. FIG. 8 shows the relationship between the current stress of each of the low-temperature polysilicon semiconductor transistor and the oxide semiconductor transistor, and light emission start voltage Vth. It should be noted that the horizontal axis in FIG. 8 corresponds to the time during which a stressful current is passed through the transistor.

In FIG. 8, when the display gradation is a high gradation and the current stress is large, the polysilicon semiconductor transistor has a smaller shift amount of light emission start voltage Vth than the oxide semiconductor transistor. For that reason, when the display gradation is a high gradation, if a polysilicon semiconductor transistor is used as the drive transistor for supplying pixel current Ids, the shift amount of light emission start voltage Vth can be reduced. That is, by using a polysilicon semiconductor transistor as the drive transistor, it is possible to stably control pixel current Ids even in a high gradation with a large current stress.

Therefore, control circuit 16 selects one drive transistor among first drive transistor Td1, which is a polysilicon semiconductor transistor, and second drive transistor Td2, which is an oxide semiconductor transistor, based on the display gradation of the display image, and supplies pixel current Ids to light emitting element EL1 via the selected drive transistor. Specifically, control circuit 16 selectively drives first selection transistor Ts1 and the second selection transistor Ts2 by using one selection gate driver among first selection gate driver 13a and second selection gate driver 13b. In this way, control circuit 16 selects one drive transistor among first drive transistor Td1 and second drive transistor Td2 by selectively driving first selection transistor Ts1 and second selection transistor Ts2.

For example, control circuit 16 selects second drive transistor Td2 when the above display gradation is lower than the predetermined display gradation, and selects drive transistor Td1 when the above display gradation is higher than or equal to the predetermined display gradation. Hereinafter, the operation of such display device 1 will be described.

### [2. Operation of Display Device]

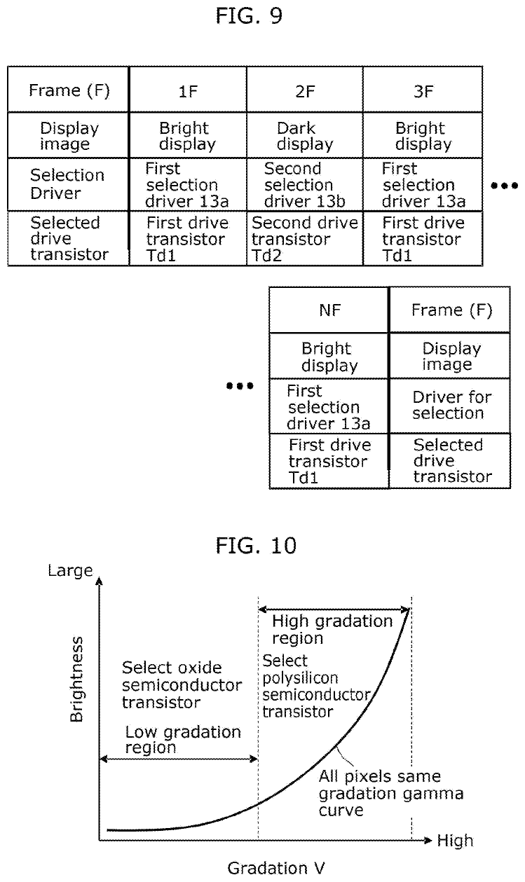

FIG. 9 is a diagram showing an example of the operation of display device 1 per frame. FIG. 10 is a diagram showing the relationship between the gradation height and the brightness of the display image.

As shown in FIG. 9, when the display image per frame is brightly displayed, control circuit 16 selects first drive transistor Td1 by using first selection gate driver 13a. In addition, when the display image per frame is darkly displayed, control circuit 16 selects second drive transistor Td2 by using second selection gate driver 13b. Specifically, when the display image is darkly displayed, since pixel current Ids flowing through drive transistor circuit TD is small, an oxide semiconductor transistor having excellent low current control is used. On the other hand, when the display image is brightly displayed, since pixel current Ids flowing through drive transistor circuit TD is large, a polysilicon semiconductor transistor having a small characteristic fluctuation due to current stress is used.

Switching between first drive transistor Td1 and second drive transistor Td2 is performed per frame of the video. Gradation calculation circuit 19 obtains the number of gradations of one frame of the video by calculation processing, and determines whether one frame of the video has a low gradation or a high gradation. Gradation calculation circuit 19 generates a mode switching signal for low gradation mode when one frame has a low gradation, generates a mode switching signal for high gradation mode when one frame has a high gradation, and outputs the mode switching signal to control circuit 16. Control circuit 16 drives first selection gate driver 13a or second selection gate driver 13b based on the obtained mode switching signal, and selects one drive transistor among first drive transistor Td1 and second drive transistor Td2.

It should be noted that as shown in FIG. 10, the boundary between bright display and dark display of the display image is predetermined by the same gradation gamma curve of all the pixels of display 12. For example, when all gradations are 256, the boundary described above is 64 gradations. However, the boundary described above is not limited thereto, and may be 32 gradations or 16 gradations.

Next, the mode switching method of display device 1 will be described.

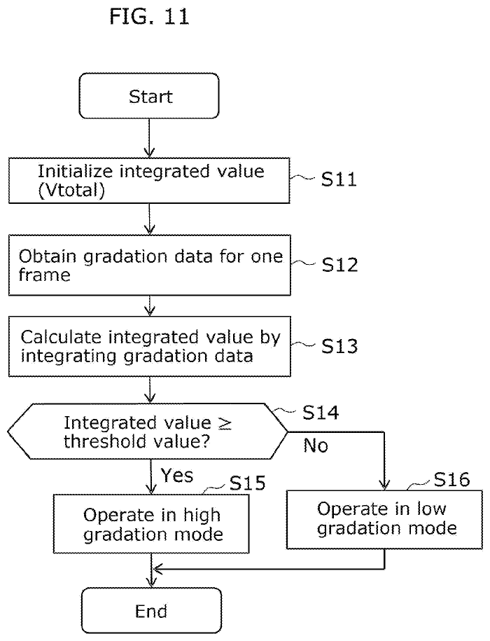

FIG. 11 is a flowchart showing an example of a mode switching method of display device 1.

First, gradation calculation circuit 19 initializes the integrated value (Vtotal) (S11). That is, the integrated value is initialized each time the operation is executed. The integrated value may be initialized to, for example, “0”. It should be noted that the integrated value is a value used for determining whether the display image is brightly displayed or darkly displayed, and is a value based on a video signal.

Next, gradation calculation circuit 19 obtains gradation data for one frame (S12). Gradation calculation circuit 19 obtains the gradation data of the video signal by reading out the video signal for one frame from frame memory 18, for example.

Next, gradation calculation circuit 19 integrates the gradation data for one frame and calculates the integrated value (S13). The integrated value is a value based on a value obtained by integrating the gradation data. In the present embodiment, the integrated value is a value obtained by integrating the gradation data for each of sub-pixel circuits 11R, 11G, and 11B. Assuming that the position of pixel circuit 10 is (x(a), y(b)), the gradation data of sub-pixel circuits 11R, 11G, 11B at the position (x(a), y(b)) are Vr(x(a), y(b)), Vg(x(a), y(b)), Vb(x(a), y(b)), respectively, the number of pixel columns is n, and the number of pixel rows is m, the integrated value is calculated based on the following Equation 1.

[Math. 1]

VTotal=Σ_{a=1,b=1}^{n,m}(Vr(x(a),y(b))+Vg(x(a),y(b))+Vb(x(a),y(b))) (Equation 1)

The integrated value may be the number of pixel circuits or the number of sub-pixel circuits including gradation data higher than or equal to the predetermined gradation data. When the predetermined gradation data is 8 bits, it may be, for example, a value corresponding to V255. When the predetermined gradation data is 8 bits, it may be, for example, V200, V220, or V240. It should be noted that the predetermined gradation data is not limited thereto, and it may be appropriately determined based on the relationship between the gradation data and the current, and the like.

Next, gradation calculation circuit 19 compares the calculated integrated value with the threshold value. Gradation calculation circuit 19 determines, for example, whether the integrated value is greater than or equal to the threshold value (S14). The threshold value is set in advance and is stored in a memory (not shown).

For example, when 80% or more of the pixels in the integrated value have a value corresponding to V255 using a threshold value based on whether 80% of the pixels of one frame have the value corresponding to V255, gradation calculation circuit 19 may determine that the one frame should be displayed in the high gradation mode. In addition, for example, when less than 20% of the pixels in the integrated value have a value corresponding to V255 using a threshold value based on whether 20% of the pixels of one frame have the value corresponding to V255, gradation calculation circuit 19 may determine that the one frame should be displayed in the low gradation mode. In addition, for example, when 50% or more of the pixels in the integrated value have a value corresponding to V255 using a threshold value based on whether 50% of the pixels of one frame have the value corresponding to V255, gradation calculation circuit 19 may determine that the one frame should be displayed in the high gradation mode.

When the integrated value is greater than or equal to the threshold value (Yes in S14), gradation calculation circuit 19 outputs a mode switching signal indicating that display device 1 is switched to the high gradation mode to control circuit 16. Control circuit 16 operates in the high gradation mode based on the mode switching signal (S15). Specifically, control circuit 16 drives first selection gate driver 13a and selects first drive transistor Td1 via first selection transistor Ts1.

When the integrated value is less than the threshold value (No in S14), gradation calculation circuit 19 outputs a mode switching signal indicating that display device 1 is switched to the low gradation mode to control circuit 16. Control circuit 16 operates in the low gradation mode based on the mode switching signal (S16). Specifically, control circuit 16 drives second selection gate driver 13b and selects second drive transistor Td2 via second selection transistor Ts2.

Gradation calculation circuit 19 determines whether the display image of each frame should be displayed in the low gradation mode or the high gradation mode, and outputs the determination result to control circuit 16 as a mode switching signal. Control circuit 16 selects a drive transistor for supplying pixel current Ids based on the mode switching signal output from gradation calculation circuit 19, and it controls the light emission of light emitting element EL1.

Next, an example of the driving method of display device 1 will be described.

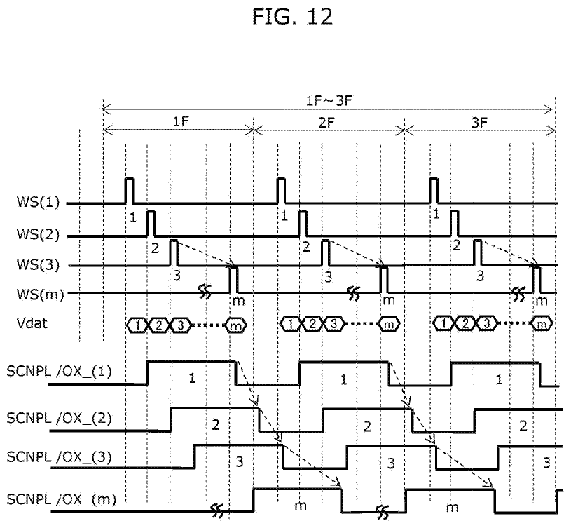

FIG. 12 is a timing chart showing an example of the driving method of display device 1. As an example, FIG. 12 shows a timing chart for three frames. In FIG. 12, the numbers in parentheses attached to the signal names indicate the rows to which the signals are supplied.

For example, in FIG. 12, WS(1) shows the drive of writing gate driver 13c in the first row, and SCNPL/OX(1) shows that one of first selection gate driver 13a and second selection gate driver 13b is being driven in the first row. It should be noted that gate drivers for selection 13a and 13b in each SCNPL/OX are selected so as to be the same selection gate driver in the 1st to mth rows in one frame. As shown in the same figure, in pixel circuits 10 of all rows 1 to m of display device 1, the drives related to WS and SCNPL/OX are performed sequentially row by row.

### [3. Cross-Sectional Structure of Display]

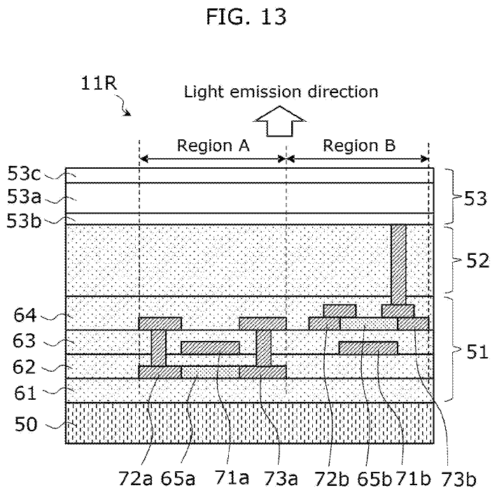

Next, the cross-sectional structure of display 12 will be described. FIG. 13 is a cross-sectional view schematically showing the structure of display 12 of display device 1.

Display 12 is an organic EL display panel including a top emission structure. In display 12, thin film transistor (TFT) layer 51 is formed on TFT substrate 50, interlayer insulating layer 52 is formed on the upper side of TFT layer 51, and EL layer 53 is formed on the upper side of interlayer insulating layer 52. It should be noted that the protective film, the sealing resin, and the sealing substrate may be laminated on EL layer 53 in this order (not shown).

Similar to the cross-sectional structure of display 12 described above, each of sub-pixel circuits 11R, 11G, and 11B also includes a structure in which TFT layer 51, interlayer insulating layer 52, and EL layer 53 are laminated in this order on TFT substrate 50. Hereinafter, sub-pixel circuit 11R will be described as an example.

EL layer 53 is configured by light emitting layer 53, metal layer 53b which is an anode, and metal layer 53c which is a cathode.

TFT substrate 50 is, for example, a glass substrate or a glass film.

TFT layer 51 includes channels 65a and 65b, insulating layers 61, 62, 63 and 64, gate electrodes 71a and 71b, drain electrodes 72a and 72b, and source electrodes 73a and 73b.

Insulating layer 61 is provided so as to cover the surface of TFT substrate 50. Drain electrode 72, source electrode 73a, and channel 65a are provided on insulating layer 61. Insulating layer 62 is provided so as to cover drain electrode 72a, source electrode 73a, channel 65a, and insulating layer 61. Gate electrodes 71a and 71b are provided on insulating layer 62. Insulating layer 63 is provided so as to cover gate electrodes 71a and 71b and insulating layer 62. Drain electrode 72b, source electrode 73b, and channel 65b are provided on insulating layer 63. Insulating layer 64 is provided so as to cover drain electrode 72b, source electrode 73b, channel 65b, and insulating layer 63.

The polysilicon semiconductor transistor is configured by channel 65, gate electrode 71a, drain electrode 72a, source electrode 73a, and a part of insulating layer 62. The oxide semiconductor transistor is configured by channel 65b, gate electrode 71b, drain electrode 72b, source electrode 73b, and a part of insulating layer 63.

As shown in FIG. 13, when display 12 is viewed in cross section, first drive transistor Td1, which is a polysilicon semiconductor transistor, is provided in the region A, and second drive transistor Td2, which is an oxide semiconductor transistor, is provided in the region B. First drive transistor Td1 and second drive transistor Td2 are provided in different regions from each other and do not overlap when viewed from the light emitting direction of light emitting element EL1.

### [4. Variation of the Cross-Sectional Structure of the Display Device]

Next, a variation of the cross-sectional structure of display 12 will be described. In the variation, an example in which the polysilicon semiconductor transistor and the oxide semiconductor transistor overlap when viewed from the light emitting direction of light emitting element EL1 will be described.

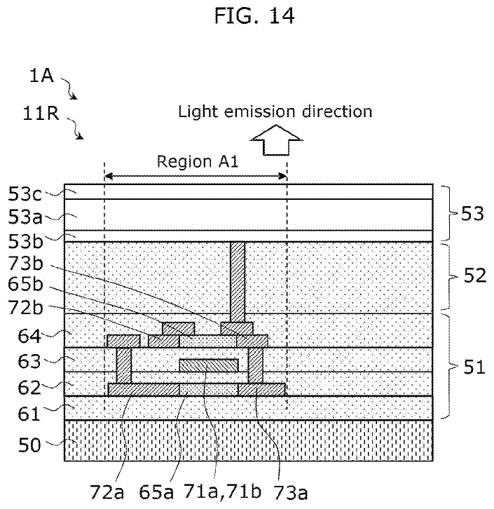

FIG. 14 is a cross-sectional view schematically showing the structure of display 12 of display device 1A according to the variation.

In display 12, TFT layer 51 is formed on TFT substrate 50, interlayer insulating layer 52 is formed on the upper side of TFT layer 51, and EL layer 53 is formed on the upper side of interlayer insulating layer 52.

TFT layer 51 includes channels 65a and 65b, insulating layers 61, 62, 63 and 64, gate electrodes 71a and 71b, drain electrodes 72a and 72b, and source electrodes 73a and 73b.

Insulating layer 61 is provided so as to cover the surface of TFT substrate 50. Drain electrode 72a, source electrode 73a, and channel 65a are provided on insulating layer 61. Insulating layer 62 is provided so as to cover drain electrode 72a, source electrode 73a, channel 65a, and insulating layer 61. Gate electrodes 71a and 71b are provided on insulating layer 62. Insulating layer 63 is provided so as to cover gate electrodes 71a and 71b and insulating layer 62. Drain electrode 72b, source electrode 73b, and channel 65b are provided on insulating layer 63. Insulating layer 64 is provided so as to cover drain electrode 72b, source electrode 73b, channel 65b, and insulating layer 63.

The polysilicon semiconductor transistor is configured by channel 65a, gate electrode 71a, drain electrode 72a, source electrode 73a, and a part of insulating layer 62. The oxide semiconductor transistor is configured by channel 65b, gate electrode 71b, drain electrode 72b, source electrode 73b, and a part of insulating layer 63.

In the variation, gate electrodes 71a and 71b are provided at the same location on the same layer and are shared by the polysilicon semiconductor transistor and the oxide semiconductor transistor. In addition, channel 65b is located directly above channel 65a, and is provided at a position where channel 65b overlaps channel 65a when viewed from the light emitting direction of light emitting element EL1, for example.

In addition, in the variation, when display 12 is viewed in cross section as shown in FIG. 14, first drive transistor Td1 which is a polysilicon semiconductor transistor and second drive transistor Td2 which is an oxide semiconductor transistor are provided in same region A1. First drive transistor Td1 and second drive transistor Td2 overlap each other at least partially when viewed from the light emitting direction of light emitting element EL1. Since first drive transistor Td1 and second drive transistor Td2 overlap each other, the area of display 12 can be made smaller than that of the above-mentioned embodiment.

### SUMMARY

Display device 1 according to the present embodiment includes pixel circuit 10 including light emitting element EL1 and control circuit 16 for controlling light emission of light emitting element EL1 via pixel circuit 10. Pixel circuit 10 includes drive transistor circuit TD that drives to supply pixel current Ids to light emitting element EL1, and drive transistor circuit TD includes first drive transistor Td1 which is a polysilicon semiconductor transistor and second drive transistor Td2 which is an oxide semiconductor transistor.

According to this, for example, when the display gradation is a low gradation, it becomes possible to supply pixel current Ids to light emitting element EL1 via second drive transistor Td2 which is an oxide semiconductor transistor. With this, it is possible to suppress deterioration of the display quality of the image when the display gradation is a low gradation. In addition, for example, when the display gradation is a high gradation, it becomes possible to supply pixel current Ids to light emitting element EL1 via first drive transistor Td1 which is a polysilicon semiconductor transistor. With this, it is possible to suppress a decrease in the brightness of the image when the display gradation is a high gradation.

In addition, control circuit 16 may select one drive transistor among first drive transistor Td1 and second drive transistor Td2, and supply pixel current Ids to light emitting element EL1 via the selected drive transistor.

According to this, for example, when the display gradation is a low gradation, it becomes possible to select second drive transistor Td2 and supply pixel current Ids to light emitting element EL1. With this, it is possible to suppress deterioration of the display quality of the image when the display gradation is a low gradation. In addition, for example, when the display gradation is a high gradation, it becomes possible to select first drive transistor Td1 and supply pixel current Ids to light emitting element EL1. With this, it is possible to suppress a decrease in the brightness of the image when the display gradation is a high gradation.

In addition, control circuit 16 may select one of the above drive transistors based on the display gradation of the display image.

According to this, it becomes possible to select second drive transistor Td2 based on the display gradation of the display image and supply pixel current Ids to light emitting element EL1. With this, it is possible to suppress deterioration of the display quality of the image when the display gradation is a low gradation. In addition, it becomes possible to select first drive transistor Td1 based on the display gradation of the display image and supply pixel current Ids to light emitting element EL1. With this, it is possible to suppress a decrease in the brightness of the image when the display gradation is a high gradation.

In addition, control circuit 16 may select second drive transistor Td2 when the display gradation is lower than the predetermined display gradation and select first drive transistor Td1 when the display gradation is higher than or equal to the predetermined display gradation.

According to this, when the display gradation is lower than the predetermined display gradation, it becomes possible to select second drive transistor Td2 and supply pixel current Ids to light emitting element EL1. With this, it is possible to suppress deterioration of the display quality of the image when the display gradation is low. In addition, for example, when the display gradation is higher than or equal to a predetermined display gradation, it becomes possible to select first drive transistor Td1 and supply pixel current Ids to light emitting element EL1. With this, it is possible to suppress a decrease in the brightness of the image when the display gradation is a high gradation.

In addition, control circuit 16 may select one of the above drive transistors per frame of the display image.

According to this, it becomes possible to select one of the above drive transistors according to the display gradation per frame of the display image. With this, it is possible to suppress deterioration of the display quality of the image when the display gradation is a low gradation, and it is also possible to suppress a decrease in the brightness of the image when the display gradation is a high gradation.

In addition, drive transistor circuit TD may further include first selection transistor Ts1 connected to one end of the input/output terminals of first drive transistor Td1 and second selection transistor Ts2 connected to one end of the input/output terminals of second drive transistor Td2, and control circuit 16 may select one of the above drive transistors by selectively driving first selection transistor Ts1 and second selection transistor Ts2.

According to this, one of the above drive transistors can be appropriately selected via first selection transistor Ts1 and second selection transistor Ts2. With this, it is possible to suppress deterioration of the display quality of the image when the display gradation is a low gradation, and it is also possible to suppress a decrease in the brightness of the image when the display gradation is a high gradation.

In addition, display device 1 may further include first selection gate driver 13a connected to the control terminal of first selection transistor Ts1 and second selection gate driver 13b connected to the control terminal of second selection transistor Ts2, and control circuit 16 may selectively drive first selection transistor Ts1 and second selection transistor Ts2 by using one selection gate driver among first selection gate driver 13a and second selection gate driver 13b.

According to this, one of the above drive transistors can be appropriately selected by using first selection gate driver 13a or second selection gate driver 13b. With this, it is possible to suppress deterioration of the display quality of the image when the display gradation is a low gradation, and it is also possible to suppress a decrease in the brightness of the image when the display gradation is a high gradation.

In addition, first drive transistor Td1 and second drive transistor Td2 may overlap each other at least partially when viewed from the light emitting direction of light emitting element EL1.

According to this, the area of display 12 of display device 1A can be reduced.

Display device 1 according to the present embodiment includes pixel circuit 10 that includes light emitting element EL1 and control circuit 16 that controls light emission of light emitting element EL1 via pixel circuit 10. Pixel circuit 10 includes drive transistor circuit TD that is driven to supply pixel current Ids to light emitting element EL1, and drive transistor circuit TD includes first drive transistor Td1 and second drive transistor Td2. Second drive transistor Td2 has a smaller slope of a linear characteristic indicating a relationship between gate-source voltage Vgs and pixel current Ids than first drive transistor Td1.

According to this, for example, when the display gradation is a low gradation, it becomes possible to supply pixel current Ids to light emitting element EL1 via second drive transistor Td2 having a small slope of the above linear characteristic. With this, it is possible to suppress deterioration of the display quality of the image when the display gradation is a low gradation.

### Other Embodiments

Although the display device according to respective exemplary embodiments of the present disclosure has been described above, the present disclosure is not limited to the individual embodiments. Forms in which various modifications conceived by those skilled in the art are applied to the present embodiment or forms constructed by combining components in different embodiments may also be included within the scope of one or more aspects of the present disclosure without departing from the spirit of the present disclosure.

For example, in the above description, a so-called 2Tr1C configuration in which pixel circuit 10 includes drive transistor circuit TD, write transistor Tws, and holding capacitance CS as a display device for emitting light of light emitting element EL1 has been described. However, the configuration of display device 1 is not limited thereto, and may be, for example, a so-called 3Tr1C configuration including drive transistor circuit TD, write transistor Tws, an initialization transistor, and holding capacitance CS.

In addition, in the above description, an example is shown in which three signal lines connected to a plurality of pixel circuits 10 are provided in each row of the matrix of display 12, but the number of signal lines is an example and not limited to this example. For example, when pixel circuit 10 has a configuration of 3Tr1C, a signal line may be further connected.

In addition, although each transistor is an N-type channel TFT element, it may be a P-type channel TFT element. In addition, some of the plurality of transistors may be N-type channel TFT elements, and other transistors may be P-type channel TFT elements. In addition, each transistor is not limited to the top gate type TFT element, and may be a bottom gate type TFT element.

In addition, the oxide semiconductor transistor is shown as a bottom gate type transistor in FIG. 13, but the present invention is not limited thereto, and the oxide semiconductor transistor may be a top gate type transistor.

In addition, first selection transistor Ts1, second selection transistor Ts2, and write transistor Tws may be a polysilicon semiconductor transistor or an oxide semiconductor transistor.

For example, gate driver 13 is arranged on one side of display 12 in FIG. 5, but may be arranged on both sides. Gate driver 13 may be configured by a shift register in which flip-flop circuits are connected in multiple stages.

In addition, gate driver 13 may be configured by any transistor of a CMOS transistor, an N-type channel transistor, and a P-type channel transistor. The gate driver may be configured by one or both of a polysilicon semiconductor transistor and an oxide semiconductor transistor.

In addition, data driver 15 may be mounted on display 12 by Chip On Glass (COG) or by Chip On Film (COF).

### INDUSTRIAL APPLICABILITY

The present disclosure can be widely used as a display device in various video display devices such as personal digital assistants, personal computers, and television receivers.

1. A display device, comprising:
a pixel circuit that includes a light emitting element; and
a control circuit that controls light emission of the light emitting element via the pixel circuit,
wherein the pixel circuit includes a drive transistor circuit that is driven to supply a pixel current to the light emitting element, and
the drive transistor circuit includes a first drive transistor that is a polysilicon semiconductor transistor and a second drive transistor that is an oxide semiconductor transistor.

2. The display device according to claim 1,
wherein the control circuit selects one drive transistor among the first drive transistor and the second drive transistor to cause the pixel current to be supplied to the light emitting element via the one drive transistor selected.

3. The display device according to claim 2,
wherein the control circuit selects the one drive transistor based on a display gradation of a display image.

4. The display device according to claim 3,
wherein the control circuit selects the second drive transistor when the display gradation is lower than a predetermined display gradation, and selects the first drive transistor when the display gradation is higher than or equal to the predetermined display gradation.

5. The display device according to claim 2,
wherein the control circuit selects the one drive transistor per frame of a display image.

6. The display device according to claim 2,
wherein the drive transistor circuit further includes a first selection transistor connected to one end of input/output terminals of the first drive transistor and a second selection transistor connected to one end of the input/output terminals of the second drive transistor, and
the control circuit selects the one drive transistor by selectively driving the first selection transistor and the second selection transistor.

7. The display device according to claim 6, further comprising:
a first selection gate driver connected to a control terminal of the first selection transistor; and
a second selection gate driver connected to a control terminal of the second selection transistor,
wherein the control circuit selectively drives the first selection transistor and the second selection transistor by using one selection gate driver among the first selection gate driver and the second selection gate driver.

8. The display device according to claim 1,
wherein the first drive transistor and the second drive transistor overlap each other at least partially when viewed from a light emitting direction of the light emitting element.

9. A display device, comprising:
a pixel circuit that includes a light emitting element; and
a control circuit that controls light emission of the light emitting element via the pixel circuit,
wherein the pixel circuit includes a drive transistor circuit that is driven to supply a pixel current to the light emitting element,
the drive transistor circuit includes a first drive transistor and a second drive transistor, and
the second drive transistor has a smaller slope of a linear characteristic indicating a relationship between a gate-source voltage and the pixel current than the first drive transistor.
